(19) United States
(12) Patent Application Publication
(10) Pub. No.: US 2019/0295111 A1
(43) Pub. Date: Sep. 26, 2019

(54) METHOD AND SYSTEM FOR TEST-DRIVEN BILAYER GRAPH MODEL

(71) Applicant: Visva Inc., Cupertino, CA (US)

(72) Inventors: Tao XIANG, Cupertino, CA (US); Zhiyong LIU, Cupertino, CA (US); Ziliang HUANG, Cupertino, CA (US)

(21) Appl. No.: 16/465,142

(22) PCT Filed: Apr. 20, 2018
(86) PCT No.: PCT/US18/28686

§ 371 Date: May 29, 2019

Related U.S. Application Data
(60) Provisional application No. 62/488,717, filed on Apr. 22, 2017.

(51) Int. Cl. G06Q 30/02; G06F 16/28; G06F 16/901

(52) U.S. Cl. CPC G06Q 30/0203; G06F 16/9024; G06F 16/285

(57) ABSTRACT

A system and a method have been provided that utilizes proprietary algorithms to generate accurate recommendations to users, resulting in highly relevant content distribution and superior Signal-to-Noise Ratio for both individual users and user groups. The system and method also build a hierarchical structure of contents and accurate categories of people based on common features that are up-to-date. A bilayer social graph model can be automatically created and updated by this method to demonstrates user categories and features. The system and method can automatically extract the features of people without pre-defining the feature categories, and further categorizes the features according to the test result. The system and method avoid certain fundamental inaccuracy inherent in existing social network system and E-business recommendation system, such as static and disjointed labeling.

### CROSS-REFERENCE TO RELATED APPLICATION

This application claims the priority from U.S. Patent Applications No. 62/488,717, filed on Apr. 22, 2017, the content of which is hereby incorporated by reference in its entirety.

### TECHNICAL FIELD

This application relates in general to a method and system for categorizing information consumers and obtaining features of the information consumers in an accurate, dynamic and simultaneous manner to optimize information recommendation, and in particular, to create a social graph that implementing the method.

### BACKGROUND

Information consumers refer to all individuals or business who come into contact and utilize information through online connections. The information that the information consumers consume is consumables. The consumables are made of individual information pieces such news, video, comment, product name, blog, letters, among others.

Many commercial systems provide information to information consumers, in areas such as social network, advertisement placement, news recommendation, among others. These systems attempt to attach labels and classifications to information and information consumers in separate processes, using data gathered historically. The labels are often inaccurate, static and archaic.

A research of prior art shows that disclosures in this area concentrate either on the recommendation based on labels or tags or on a recommendation based on people relationships. These methods can generate meaningful recommendations, but also generate a lot of noises because labels are rigid and cannot describe people's interest accurately, and people who have close relationships with users may not share the same interests.

U.S. Pat. No. 8,095,432 to Intuit Inc. (2009) relates to a method of making a recommendation, comprising: obtaining a plurality of recommendations for a plurality of items from a plurality of members of a social networking utility; ranking the plurality of recommendations based on a relationship proximity of the plurality of members to an inquiring member within the social networking utility. The ranking of recommendations is based on social relationship proximity. As discussed before, social friends don't necessarily share the same interests, so this recommendation mechanism is flawed and will generate excessive noise.

Some existing SNS or relevant systems tried to categorize their users based on their interests, but their approach is to use predefined features from historical data. The categories of features used by the existing systems are almost all pre-defined, such as Music, Sports, Travel, and their sub-categories. Such a pre-defined system suffers at least the following three shortcomings. First, it is highly time-consuming to define the features system, especially for an elaborate depth system. Second, it cannot accurately capture the information consumer's features, including missing many features of the information consumers. Third, it cannot adapt to newly emerged features.

Thus, there remains a need for accurate, up-to-date, and simultaneous categorization of information consumers and information.

### SUMMARY

This disclosure is generally directed to, at least in part, a method and system for creating and maintaining accurate, up-to-date, and simultaneous categorization of information consumers and information. As an implementation of the method and system, a bilayer graph model can not only automatically extract information consumers' features based on their behaviors but also simultaneously categorize the information consumers based on the features extracted. The bilayer graph manifests the categorization, with the first layer comprising the nodes each of which denotes one information consumer and the second layer comprising the nodes each of which denotes one feature extracted. The nodes of the first layer are not linked mutually but can be linked indirectly through the nodes of the second layer; the nodes on the second layer linked to some nodes in the first layer and can be linked to other nodes in the second layer and hierarchically categorized, depending on specific applications.

A specific implementation of a method and system for accurate, up-to-date, and simultaneous categorization of information consumers and information. and presenting the result in a social graph, is a product VISVA. The system website, https://www.visva.com, the system publication (including user guild, tutorials, videos, and others), and other publication about the system are incorporated by reference. Embodiments include an information system, specifically an information system that automatically categorizes content and people and provides a high signal-to-noise ratio (SNR) and connects users with like-minded people.

In some embodiments, a method for accurate, up-to-date, and simultaneous categorization of information consumers and information is provided, comprising the steps of providing a group of information consumers and a plurality of information pieces; determining a qualified information piece by sending information pieces to the information consumers and evaluating interactions of the information consumers towards the sent information pieces; associating the qualified information piece to information consumers based on the evaluation; and extracting a feature from the associated qualified information pieces.

In some embodiments, determining the qualified information piece is performed through a stepwise test or spreading-test comprising the steps of sending the information pieces only some of the information consumers; quantifying the response of the information consumers; and determining the qualified information piece based on values derived from quantifying.

In some embodiments, determining the qualified information piece is performed by dividing the group of the information consumers into multiple test-groups for testing; determining a predetermined single testing threshold and predetermined multiple testing thresholds; sending an information piece to a test-group; evaluating the responses for the test-group in response to the sending by calculating a value based on the responses; comparing the calculated value vs. the predetermined value, and based on the comparison, either sending the information piece to next test-group and evaluating the responses of the next group when the calculated value exceeds the predetermined single testing threshold, or stopping sending the information piece when the calculated value does not exceed the predetermined single testing threshold; aggregating the calculated value from each tested group and determining the qualified information piece when the aggregated values exceed the predetermined multiple testing thresholds.

In some embodiments, the qualified information piece is sent to the entire group of information consumers.

In various embodiments, preconceived connections are not attached to information consumers, and preconceived labels are not assigned to the information pieces.

In some embodiments, information consumers sharing a common feature are categorized into a new group. A new information piece is sent to the new group of the information consumers based on the compatibility of the new information piece and the feature of the new group.

In some embodiments, the system extracts multiple features from qualified information pieces features and establishes a hierarchical relationship between two features by linking two features that have a common qualified information piece from which the two features are extracted; assigning a higher level to the feature that has a higher number of the qualified information pieces.

In some embodiments, the system establishes a hierarchical relationship between two features based on the presence of shared qualified information pieces and the numbers of qualified information pieces respectively associated with the two features.

In some embodiments, the information consumers and the information pieces are chosen from at least one of the following combinations: the information consumers comprise social network users, and the information pieces comprises news, comment, audios, videos, arts, articles, or names; the information consumers comprise ecommerce participants, and the information pieces comprise merchandise sold or advertised online; the information consumers comprise online platforms marketing Applications, and the information pieces comprises name of Applications; the information consumers comprise recruiting agencies, human resource departments, and employers, and the information pieces comprises resumes; and the information consumers comprise users of online education platform, and the information pieces comprises textbooks, classes, lectures, study material, and topics.

In some embodiments, a computing device is provided comprising one or more processors and memory to maintain a plurality of components executable by the one or more processors, the plurality of components comprising: a collection submodule configured to provide a group of information consumers and a plurality of information pieces; a determining submodule configured to determine qualified information pieces by evaluating the response/interactions the information consumers towards the information pieces; an association submodule configured to associate an information consumer with the qualified information pieces when the evaluated response exceeds a threshold; and an extraction submodule configured to extract a feature from the qualified information pieces.

In some embodiments, one or more non-transitory computer-readable media storing computer-executable instructions that, when executed on one or more processors, causes the one or more processors to perform the system operations.

In some embodiments, a method for generating a bilayer social graph is provided, including the steps of providing a first layer comprising information consumer nodes denoting information consumers, wherein the nodes do not connect mutually; providing a second layer comprising feature nodes representing automatically extracted features of the information consumers; and connecting the information consumer nodes to the feature nodes wherein the feature node is extracted from the qualified information pieces associated with the information consumer.

In some embodiments, the method for generating a bilayer social graph further includes: providing a plurality of information pieces; determining qualified information pieces by sending information pieces to the information consumers and evaluating interactions of the information consumers towards the sent information pieces; associating the qualified information piece to information consumers based on the evaluation; and extracting the features of the information consumers from the associated qualified information pieces.

In some embodiment, determining the qualified information piece is performed through a stepwise test or spreading-test comprising the steps of: sending the information pieces to only some of the information consumers; scoring the response of the information consumers; and determining the qualified information piece based on values derived from scoring.

In some embodiments, determining the qualified information piece is performed by dividing the group of the information consumers into multiple test-groups for testing; determining a predetermined single testing threshold and predetermined multiple testing thresholds; sending an information piece to a test-group; evaluating the responses for the test-group in response to the sending by calculating a value based on the responses; comparing the calculated value vs. first predetermined value, and based on the comparison, either sending the information piece to next test-group and evaluating the responses of the next group when the calculated value exceeds the predetermined single testing threshold, or stopping sending the information piece when the calculated value does not exceed the predetermined single testing threshold; aggregating the calculated value from each tested group and determining the qualified information piece when the aggregated values exceed the predetermined multiple testing thresholds.

In some embodiments, features nodes may be connected by linking two features that share a common qualified information piece, wherein the connection direction runs from the feature node associated with a higher number of qualified information pieces to the node associated with a lower number of qualified information pieces. The direction of the connections in the social graph shows a hierarchy between two features, with the direction running from higher to lower hierarchy.

In some embodiments, an information piece, especially those highly relevant, can be spread to selected information consumers by selecting a matching feature node and sending the information piece only to those information consumer nodes that are connected to the matching feature node.

In some embodiments, a bilayer social graph is provided that includes an information consumer layer comprising information consumers nodes unconnected mutually (but can be connected via a feature node in the second layer), and an automatically extracted feature layer comprising feature nodes representing features of the information consumers. The connections between information consumers nodes and feature nodes denote a feature of the information consumers. In some embodiment, a directional connection between feature nodes is provided, denoting a hierarchical relationship between the features, wherein the features are extracted from qualified information pieces that are associated with information consumers through a stepwise evaluation of interests on the information pieces.

Still, other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is to be noted that various changes and modifications practiced or adopted by those skilled in the art without creative work are to be understood as being included within the scope of the present invention as defined by the appended claims.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative computing environment used to categorize information consumers, extract features, and create and operate a social graph reflecting the categories and features of information consumer, according to some embodiments. The following numbers indicate items: 101 social Networks; 102 Traditional media; 103 Applications; 104 Recommendation Engine; 105 Content Module; 106 Data Servers; 107 Application Servers.

FIG. 2 is a flow diagram of an illustrative process to categorize information consumers and extract features by a stepwise test or spreading-test method, according to some embodiments. The following numbers indicate the steps of: 201 Start of Content Distribution and Processing; 202 Content sent to test group 1; 203 Test group 1 interacts with the content and decide whether they approve it; 204 Content not approved by test group 1 and discarded; 205 System evaluates whether the content gains enough value to be broadcast; 206 Content broadcasted to the group; and 207 Content sent to the next test.

FIG. 3 is a schematic diagram of illustrative bilayer social graph model illustrating the bilayer graph model. The top layer are nodes denoting information consumers and the second layer are nodes denoting the features extracted.

FIG. 4 is an illustration of hierarchical structures for features extracted and further analyzed/mined in the social graph.

### DETAILED DESCRIPTION

The disclosure, including both the system and the method, is not only able to present relevant information to users, but also able to connect people with same specific characteristics or needs. Further objects and advantages will become apparent from a study of the following description and the accompanying drawings.

The common architectures and specific embodiments of the disclosure will be described in detail, referring to the accompanying figures. The disclosure can be applied to various scenarios, e.g., social media, social network, e-Commerce, marketing platform, recruiting and job-hunting, knowledge classification, and others. Using the common architectures, different scenarios of the application can be realized. The processes and systems described herein may be implemented in a number of ways. Example implementations are provided below with reference to the following figures.

There are multiple examples of information consumers and consumables and attempts to efficiently promote system distribution of information. One example is a social network, wherein information consumers are participants and consumables is information pieces shared by the participants. The system depends on classification. The classification is done by classifying participating people through known or professed categories or traits such as age, interest, job, and other pre-defined characteristics. Information is tagged to participants, and the focus is on the person as reflected by these tags.

Another area for information consumers and consumables interactions is E-commerce. A consumer is a person, and the consumable is information of merchandise. The existing solution is to classify merchandise.

Another area for information consumers and consumables interactions is information flow recommendation. The information consumers are persons, and consumable are information contents. The existing solutions also rely on labels. People and contents are labeled, the so-called personalized recommendation is attempted through label-matching. Again, the focus is on the person as reflected by these labels.

Other area includes big data utilization, recruitment/human resource, and marketing studies. The common challenge facing current systems and methodology is inaccurate labels and high noise-to-signal ratio.

Referring to conventional techniques, noise on social media is critical considering people are overloaded with information. Failing to distinguish relevant content from the chaos is preventing people from getting information effectively.

In current Internet products, users are commonly inundated with excessive amount of information unable to consume. For most Internet users, the received information is overloaded, either from systems, personal contacts, or content sharing. Most of the information are not relevant to the users, therefore, for Internet users, there is too much noise in the system, and the SNR is too low. On the other hand, certain relevant information may not reach relevant users, the efficiency of information distribution is low.

Labels (or tags) are commonly used by current products to filter information. Users can also acquire information shared by somebody by manually following that person. The shortcomings of these methods are as follows,

Labels cannot represent people's interest accurately; they cannot describe the characteristics of information accurately, either. Thus label-based information orientation and distribution cannot improve the signal-to-noise ratio.

Labels are static and rigid; they cannot be adjusted or adapted dynamically. Thus, they cannot track the changes of people's interest.

Following specific people means following everything he/she distributes or shares. This is again not efficient because there are huge differences among people.

To sum up, information broadcasting (or group broadcasting) based on labels and personal connections (strong relationship) is not efficient and of low SNR.

The common drawbacks of these systems are: the category or classification used are rigid and not sufficiently refined or accurate; the classification is static and does not reflect change in the consumer and the information pieces; even if the data are updated, the category and the classification used are based on historical data and lag behind reality; the classification of the consumer and information pieces are performed separately, which deviates from real situations. As a result, the categorization is not accurate, and information recommendation is also not accurate.

A fundamentally important task of such systems is to categorize the information consumers based on their features accurately. If one can accurately extract the features of the information consumers, we can solve the troubles such as low SNR in a natural way. For instance, in social network system (SNS), the feature may denote the different types of interests, and the users are linked by their common favorites. If so, the relevant messages can be accurately pushed from one user to another one according to their common favorites. But in conventional SNS, two users are usually assigned a linkage from the beginning. That is, all of the interesting messages of one user may be pushed to another user linked to him/her. However, many of the favorites of one user may be different from the other one, resulting in that the other user may receive many uninterested messages.

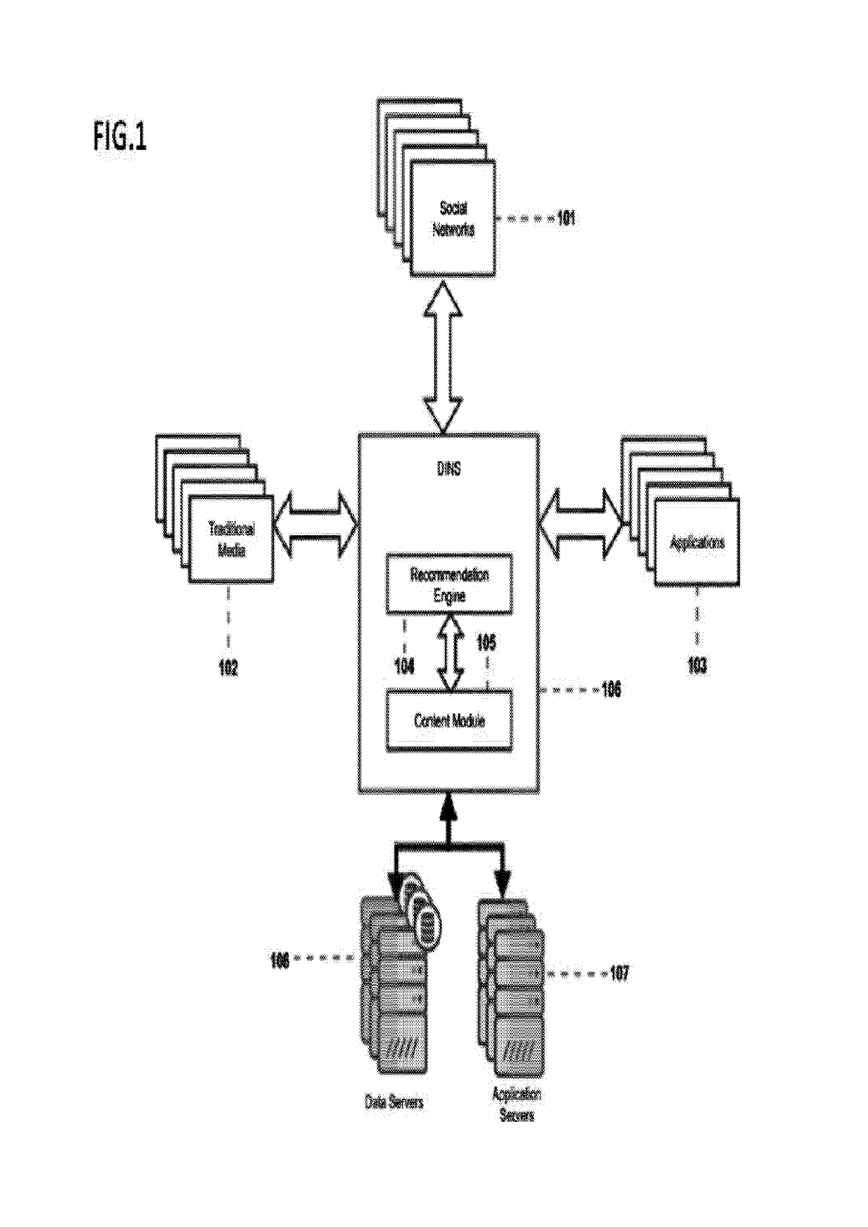

FIG. 1 shows a platform or system 100 that may utilize distributed intelligence and networking mechanism to execute the method disclosed here, in some embodiments. The system comprises two main layers/modules: a recommendation engine (104) and a content module (105). Recommendation engine receives contents and generates recommendations of content (information such as social media posts, emails, instant messages, music and videos, services, products and other applications) to users and works between users and content. It also evaluates the response and grades the interactions of information consumers who received the recommendation/contents. In addition, it categorizes information consumers and extracts features of the information consumers. It also creates and updates the hierarchical structure of content and networks of users connected via features/topics.

The recommendation engine (104) includes several submodules that act in concert to perform its functions. These submodules include a collection submodule configured to provide a group of information consumers, and a plurality of information pieces; a determining submodule configured to determine qualified information pieces by evaluating the response the information consumers towards the information pieces; an association submodule to associate an information consumer with the qualified information pieces when the evaluated response exceeds a threshold module; and an extraction submodule configured to extract a feature from the qualified information pieces. No prior knowledge on connections between the information consumers are needed, and no labels for information pieces are needed. In various embodiments, the preconceived or known connections and labels are filtered out by the content submodule.

The recommendation engine furthers includes a content module contains all content generated by users, either originally created by users or collected by users and introduced to the system. This content is categorized in very high definition, to a level that cannot be described by text labels.

The system interacts with at least three types of external systems: social networks (such as Facebook, Twitter, Pinterest), traditional media (such as NBC, CBS, New York Times), and applications (such as Google App, gaming Applications, Amazon App), in one embodiment. The system provides interfaces to and from social networks so that users can easily transfer content. In some embodiments, the system may interact with the more specialized system, such as job search sites with frequent resume postings, or e-commerce sites that have a high volume of orders.

In some embodiments, by transferring quality content to the system, users will get rewarded financially, socially, or spiritually. The system partners with traditional media to acquire quality content and facilitates monetization and user acquisition. The system serves as a proxy for applications and services. It can help users find most relevant services and service providers, while the system gets to know the users better by analyzing their interactions with various applications.

In one embodiment, the system is physically built upon data servers and application servers that all reside in the clouds. The system is scalable linearly. As the growth of user base and content base, more servers can be readily added to process service requests and store content.

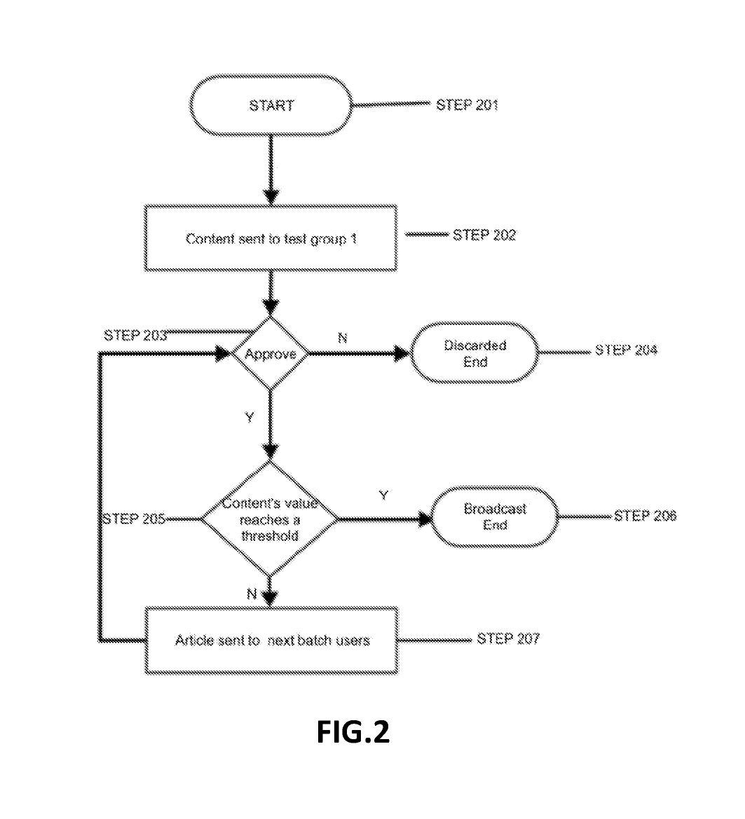

FIG. 2 is a flow diagram of an illustrative process to categorize information consumers and extract features by a stepwise test or spreading-test method, according to various embodiments. When a content, i.e., an information piece, comes into the system (Step 201), it may be sent or directed to one or multiple groups of information consumers (Step 202). In each group, a specific percentage of information consumers (test-group) are selected to receive the content or information piece. The response of the test group is evaluated (Step 203). Specifically, the evaluation was performed by scoring, quantifying, or grading the actions or interactions of the information consumers within the test-group towards the information piece. Every action done by the information consumers on the content generates a score. The combined score from the test-group, i.e., the test-group score, is compared to a predetermined value, i.e., the single testing threshold. If the threshold is not met, the information piece ceases to be propagated further and is discarded (Step 204). If the threshold is met, the test group score is further compared to a second predestined value, i.e., the multiple testing thresholds (Step 205). If the multiple testing thresholds are met, the sending/testing within this group stops and the information piece is determined to be a qualified information piece (Step 206). If the multiple testing thresholds is not met, the content is sent to the next test-group (Step 207) and undergoes the same testing steps as performed in the previous test-group, to decide whether the content will be further distributed, determined to be a qualified information piece, or discontinued in the group, with the exception that, in Step 205, the test-group scores from previous test-groups are combined to compare with the multiple testing thresholds. This testing process may repeat through many test-groups until the content is either received by everybody in the group or discontinued somewhere in between. A qualified information piece is determined when the group multiple testing thresholds are met.

A qualified information piece is generally relevant to the group of information consumers from which it has been determined and may be broadcasted to the entire group of information consumers in some embodiment.

A qualified information piece, especially one that is obtained from a large group of information consumers, or one that is confirmed through multiple groups of information consumers, is often a reliable indicator or trait of those information consumers who scored highly in the stepwise test. The qualified information piece can be associated to the information consumers who scored highly in the stepwise test. The information consumers can thus be categorized according to the association with a common feature.

Compared to all existing methodology and commercial practice, the advantages of this approach are: there is no need to introduce prior relationship among information consumers; there is no need to define what the features are. Both the introduction and the definition will introduce inaccuracy and static, outdated limitations. Instead, the system automatically and simultaneously categorizes the information consumers and information by testing. The results are accurate, up-to-date, and has fewer biases.

One or more feature can be extracted from the qualified information piece that is indicative of interest, connectivity or other traits of the information consumers. A feature may be an element present in the information piece or content. A feature may also be the information piece itself, in some embodiments.

After multiple features are extracted, a hierarchical relationship between some features may emerge that reflects underlying relationships of the features. For example, when feature 1 consists two elements and feature 2 consists of one the two elements, it can be observed in a large group of information consumers that those information consumers associated with the feature 2 tend to always be associated with the feature 1, but not vice versa. By analysis of the extracted feature from the associated qualified information pieces, the conclusion can be drawn about the relationship between features. Because the features are automatically extracted by the system and no human input is necessary, new features and the relationship can be uncovered by the system.

As can be seen, in addition to providing an accurate, up-to-date, and simultaneous categorization of information consumers and information pieces, the system also provides a method and system to unveil or confirm the relationship between features.

The implementations of the disclosed systems and processes are better illustrated by examples.

In one embodiment, the information consumers comprise social network users, and the information pieces comprise news, comment, audios, videos, arts, articles, or names. The system can be used to discover the interest of the users, decide popular information to send, and recommend advertisement placement.

Furthermore, scoring or evaluating the response or interactions of the users or information consumers is performed by tracking the actions or interactions or behaviors including creating a comment, reading the news, upvoting, and transferring the information piece. Based on the behavior type, intensity, and frequency, the system will assign a value. A typical behavior-value table for social networks is listed below.

| Behavior | | | | | |
|---|---|---|---|---|---|
| type | Creating | Reading | Commenting | Upvoting | Transferring |
| Value | 5 | 1 | 4 | 2 | 5 |

After the stepwise test or spreading-test as described before, if the value scored by a message exceeds the multiple testing thresholds, the message is determined to be a qualified information piece, a feature is generated or extracted based on the message, and all of the users who have a large enough individual score on the message will be associated or assigned the feature. In this sense, the feature can also be regarded as a topic, which categorizes all of the information consumers displaying sufficient interest.

In another embodiment, the information consumers comprise potential customers in E-commerce. The information pieces are names of the merchandise. Scoring or evaluating the response of the users or information consumers is performed by tracking the actions or interactions or behaviors including clicking, reading information, searching similar items, saving the link, and purchasing. A typical behavior-value table for online purchasing is listed below. A typical behavior-value table for social networks is listed below.

| Behavior type | Clicking | Reading | Searching | Saving | Purchasing |
|---|---|---|---|---|---|
| Value | 1 | 2 | 3 | 3 | 5 |

Examples of information consumers and information pieces combination include online platforms marketing Applications and name of Applications, recruiting agencies/human resource departments/employers and resumes, online education platform and the information pieces comprise textbooks, classes, lectures, study material, and topics;

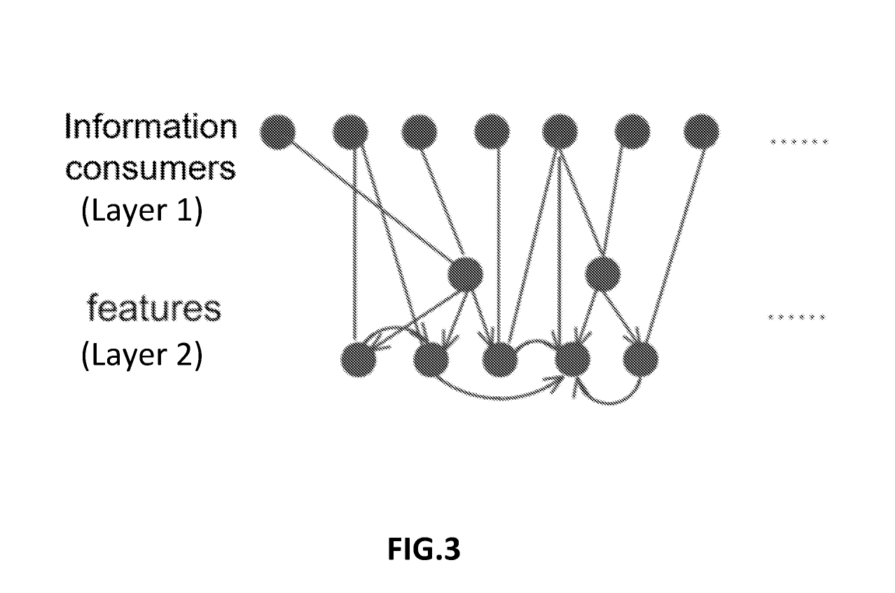

FIG. 3 is a schematic diagram of illustrative bilayer social graph model. In various embodiments, the system implements the methods disclosed and presents the information consumers and their associated features in a bilayer social graph. The first layer includes nodes denoting information consumers and the second layer includes nodes denoting the features extracted from the information consumers. In various embodiments, the system automatically extracts feature, simultaneously categorize information consumers based on the features extracted, and present the result in the bilayer graph model. The nodes of the first layer, or the information consumer layer, represents information consumers. The nodes of the first layer are not linked mutually since no perceived connections are introduced into the social graph.

The nodes in the second layer, or the feature layer, represent features extracted from qualified information pieces and are associated with their respective information consumers. The feature extraction process has been described infra.

Each feature is represented as a feature node in the second layer, and each feature node has two metrics: the first metric is the information consumers associated with it (i.e., those information consumers who have scored sufficiently score in the stepwise test on the particular information piece, from which the feature is extracted), and the second metrics is the number of qualified information pieces from which the feature is extracted or derived.

Regarding the first metric, the bilayer social graph represents the metric by making a connection, i.e., edge, between the feature node in the second layer and its respective information consumer nodes in the first layer. Thus, sharing a common feature can be conveniently visualized or presented by edges emanating from the features. To disseminate an information piece to the interested group, the system can first locate the information piece and subsequently send it along the edges towards the first layer.

A features node in the second layer may be connected to another feature node, where the connection may represent a hierarchical relationship between features. By exploring and analyzing the connection, insights can be gained into the relationship between features.

The second metric of the feature, i.e., the number of qualified information pieces from which the feature is extracted or derived, can be important in determining the direction of connection and establishing a hierarchical relationship between two features. In one embodiment, the system makes a directional connection by linking two features that have common qualified information pieces from which the two features are extracted and assigning a higher level to the feature that has a higher number of the qualified information pieces.

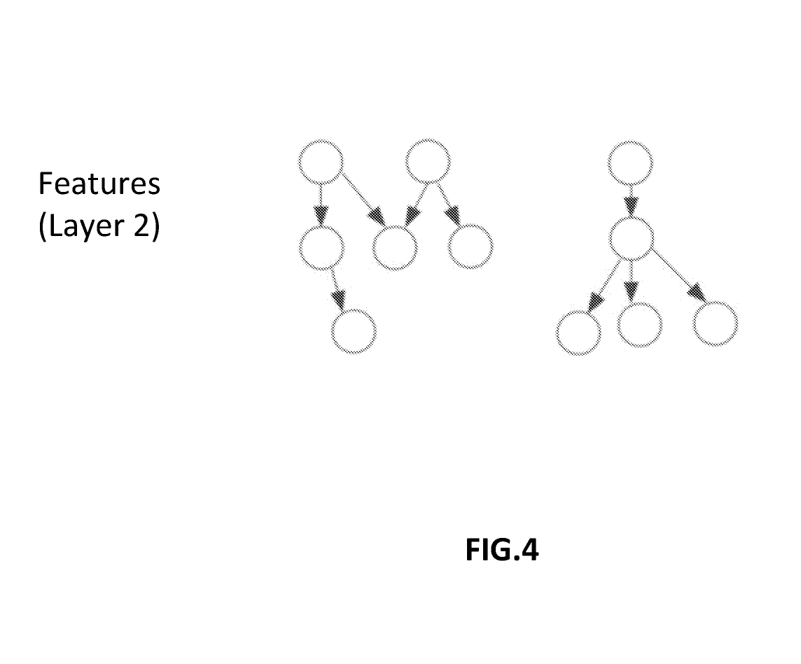

For example, if the numbers of qualified information pieces of feature node A and feature node B are a and b, respectively, and the number of common qualified information pieces of A and B is c, then the weight of the edge from node A to B is calculated as c/b, and the weight of the edge from node B to A is c/a. Therefore, by the above means, a weighted directed (asymmetric) graph can be constructed for the features. The graph represents the structure of the features. Suppose, in the case of b=c and a>c, then feature B is likely a part of feature A, and the direction of A-B direction runs unequivocally from A to B, because A encompasses B and is at a higher level than B. This can be particularly helpful in some applications. For instance, for the E-business system, the graph gives the relationship between different products; or for the knowledge system where each feature represents a knowledge point, the graph forms a knowledge map indicating one subject or topic is encompassed or connected to another subject or topic. FIG. 4 is an illustration of hierarchical structures for features mined in the social graph, which reveals hierarchical relationships among the features.

It will be readily understood that the components of the present disclosure, as generally described and illustrated in the Figures herein, could be arranged and designed in a wide variety of different configurations. Thus, the following the more detailed description of the embodiments of the disclosure, as represented in the Figures, is not intended to limit the scope of the disclosure, as claimed, but is merely representative of certain examples of presently contemplated embodiments in accordance with the disclosure. The presently described embodiments will be best understood by reference to the drawings, wherein like parts are designated by like numerals throughout.

Embodiments in accordance with the present disclosure may be embodied as an apparatus, method, or computer program product. Accordingly, the present disclosure may take the form of an entire hardware embodiment, an entire software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer usable or computer readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present disclosure may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

### CONCLUSION

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

What is claimed is:

1. A method for categorization of information consumers and information, comprising:
providing a group of information consumers and a plurality of information pieces;
determining a qualified information piece by sending information pieces to the information consumers and evaluating interactions of the information consumers towards the sent information pieces;
associating the qualified information piece to information consumers of the group of information consumers based on the evaluation; and
extracting a feature from the associated qualified information pieces.

2. The method according to claim 1, wherein determining the qualified information piece is performed through a spreading-test comprising the steps of:
sending the information pieces to only some of the information consumers;
quantifying responses of the information consumers; and
determining the qualified information piece based on values derived from quantifying.

3. The method according to claim 2, wherein determining the qualified information piece is performed by:
dividing the group of the information consumers into multiple test-groups for testing;
determining a predetermined single testing threshold and predetermined multiple testing thresholds;
sending an information piece to a test-group;
evaluating the responses for the test-group in response to the sending by calculating a value based on the responses;
comparing the calculated value vs. the predetermined value, further comprising:
sending the information piece to a next test-group and evaluating the responses of the next group when the calculated value exceeds the predetermined single testing threshold,
stopping sending the information piece when the calculated value does not exceed the predetermined single testing threshold;
aggregating the calculated values from each tested group; and
determining the qualified information piece when the aggregated values exceed the predetermined multiple testing thresholds.

4. The method according to claim 3, further comprising the step of:
sending the qualified information piece to an entire group of information consumers.

5. The method according to claim 1, wherein preconceived connections are not attached to the information consumers, and preconceived labels are not assigned to the information pieces.

6. The method according to claim 1 further comprising the step of:
categorizing a new group of information consumers according to their sharing of a common feature; and
sending a new information piece to the new group of the information consumers based on compatibility between the new information piece and the common feature.

7. A method according to claim 1, further comprising:
extracting more than one features; and
establishing a hierarchical relationship between two features by:
linking two features that have a common qualified information piece from which the two features are extracted; and
assigning a higher level to the feature that has a higher number of the qualified information pieces.

8. The method according to claim 1, wherein the information consumers and the information pieces are chosen from at least one of the following combinations:
the information consumers comprise social network users, and the information pieces comprise news, comment, audios, videos, arts, articles, or names;
the information consumers comprise online shopping participants, and the information pieces comprise merchandise sold or advertised online;
the information consumers comprise online platforms marketing Applications, and the information pieces comprise names of Applications;
the information consumers comprise recruiting agencies, human resource departments, and employers, and the information pieces comprise resumes; and
the information consumers comprise users of online education platform, and the information pieces comprise textbooks, classes, lectures, study material, and topics.

9. The method according to claim 1, further comprising:
updating the feature by sending additional information pieces.

10. One or more non-transitory computer-readable media storing computer-executable instructions that, when executed on one or more processors, causes the one or more processors to perform acts as described in claim 1.

11. A method for generating a bilayer social graph, comprising:
providing a first layer comprising information consumer nodes denoting information consumers, wherein the nodes do not connect mutually;
providing a second layer comprising feature nodes representing automatically extracted features of the information consumers; and
connecting the information consumer nodes to the feature nodes wherein the feature nodes are extracted from qualified information pieces associated with the information consumer.

12. The method according to claim 11, wherein the qualified information pieces are determined by:
providing a plurality of information pieces;
determining qualified information pieces by sending the information pieces to the information consumers and evaluating interactions of the information consumers towards the sent information pieces;
associating the qualified information piece to information consumers based on the evaluation; and
extracting the features of the information consumers from the associated qualified information pieces.

13. The method according to claim 11, further comprising determining the qualified information pieces through a spreading-test comprising the steps of:
sending the information pieces to only some of the information consumers;
scoring responses of the information consumers; and
determining the qualified information piece based on the scoring.

14. The method according to claim 11, wherein determining the qualified information pieces is performed by:
dividing the group of the information consumers into multiple test-groups for testing;
determining a predetermined single testing threshold and predetermined multiple testing thresholds;
sending an information piece to a test-group;
evaluating the responses for the test-group in response to the sending by calculating a value based on the responses;
comparing the calculated value vs. the predetermined value, further comprising:
sending the information piece to a next test-group and evaluating the responses of the next group when the calculated value exceeds the predetermined single testing threshold; and
stopping sending the information piece when the calculated value does not exceed the predetermined single testing threshold;
aggregating the calculated value from each tested group; and
determining the qualified information piece when the aggregated values exceed the predetermined multiple testing thresholds.

15. The method according to claim 11, further comprising:
connecting the feature nodes by directionally linking two features that shares a common qualified information piece, wherein the direction runs from the feature node associated with a higher number of qualified information pieces to the node associated with a lower number of qualified information pieces.

16. The method according to claim 15, further comprising:
characterizing relationship of features based on the connections and direction of the connections in the social graph.

17. The method according to claim 11, further comprising:
spreading an information piece to information consumers by selecting a feature node and sending the information piece only to the information consumer nodes connected to the feature node.

18. The method according to claim 11, wherein the information consumers and the information pieces are chosen from at least one of the following combinations:
the information consumers comprise social network users, and the information pieces comprise news, comment, audios, videos, arts, articles, or names;
the information consumers comprise online shopping participants, and the information pieces comprise merchandise sold or advertised online;
the information consumers comprise online platforms marketing Applications, and the information pieces comprise names of Applications;
the information consumers comprise recruiting agencies, human resource departments, and employers, and the information pieces comprise resumes; and
the information consumers comprise users of online education platform, and the information pieces comprise textbooks, classes, lectures, study material, and topics.

19. A method according to claim 11, further comprising updating the feature by providing additional information pieces.

20. A computing device comprising:
one or more processors; and memory to maintain a plurality of components executable by the one or more processors, the plurality of components comprising:
a collection submodule configured to provide a group of information consumers, and a plurality of information pieces;
a determining submodule configured to determine qualified information pieces by evaluating interactions the information consumers towards the information pieces;
an association submodule configured to associate an information consumer with the qualified information pieces when evaluated response exceeds a threshold; and
an extraction submodule configured to extract a feature from the qualified information pieces.
